(19) United States
(12) Patent Application Publication
(10) Pub. No.: US 2005/0040189 A1
(43) Pub. Date: Feb. 24, 2005

(54) Butter dispenser with internal bias pressure

(76) Inventor: Levi Gil Shoshan, Wellington, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/922,354

(22) Filed: Aug. 20, 2004

Related U.S. Application Data
(60) Provisional application No. 60/496,818, filed on Aug. 21, 2003.

(51) Int. Cl. A23G 1/00

(52) U.S. Cl. 222/433

(57) ABSTRACT

A disposable food container and dispenser for transporting from point of manufacture to storing foods such as butter, margarine or the like, which can also be used for dispensing the food at the point of use, for example at a table, which has upper and lower container members connected by a biased hinge member, where said bias is to maintain the container members in either a closed relationship or an open relationship, the latter permitting access to the food contents of the container/dispenser, by consumers of the food.

### CROSS-REFERENCE TO RELATED APPLICATION

This application claims the benefit of U.S. Provisional Application Ser. No. 60/496,818, filed on Aug. 21, 2003, entitled BUTTER DISPENSER WITH INTERNAL BIAS PRESSURE.

### TECHNICAL FIELD OF THE INVENTION

The present invention relates to food containers and dispensers. In particular, the present invention relates to a disposable food container and dispenser that is provided with a tab to secure the container/dispenser in a first, i.e. closed, position for enclosing and preserving the contents of the container/dispenser and, after tab removal, automatically opens to a second position as a result of internal bias pressure to permit access to contents in the container/dispenser.

### BACKGROUND OF THE INVENTION

This invention relates generally to devices for storing and dispensing slices of bar-shaped soft foods such as butter, margarine or the like. More particularly, the present invention relates to devices for storing and dispensing pats of butter and margarine.

Various types of dispensers for storing and dispensing bars of butter or margarine are known. However, the soft semi-solid nature of butter and margarine, especially at room temperature, imposes limitations on the usefulness of conventional apparatus. Generally, butter and margarine adhere to surfaces that they contact. When a stick of such material is pushed out of a container, a film of butter or margarine is left on these surfaces. Therefore, butter and margarine dispensers require frequent and careful cleaning to ensure that such deposits do not turn rancid. In addition, butter and margarine are easily pushed through orifices, butt-joints, and other such irregularities in the dispenser and can foul areas of dispensers which are not intended to come into contact with the butter or margarine.

Thus, there is a need for a disposable butter container and dispenser, and particularly a butter container and dispenser that allows access to the contents therein without having unnecessary unsanitary contact with the container.

### SUMMARY OF THE INVENTION

The present invention eliminates the above-mentioned needs for a sanitary disposable butter container and dispenser by providing a disposable butter container and dispenser that utilizes internal bias pressure to facilitate automatic opening of the container/dispenser.

In accordance with the present invention, there is provided a disposable butter container and dispenser that includes an upper container member, a lower container member, a hinge member under internal bias pressure integrated to the upper container member and the lower container member, wherein the hinge member under internal bias pressure places the upper container member in a first position relative to the lower container member, and a tab member to secure the upper container member in a second position relative to the lower container member.

### BRIEF DESCRIPTION OF THE DRAWINGS

FIG. 1 is an isometric top view of the preferred embodiment of the present invention.

FIG. 2 is an isometric front view of the present invention of FIG. 1.

FIG. 3 is an isometric view of the present invention of FIG. 1.

FIG. 4 is an isometric side view of the present invention of FIG. 1.

### DETAILED DESCRIPTION OF THE PREFERRED EMBODIMENT

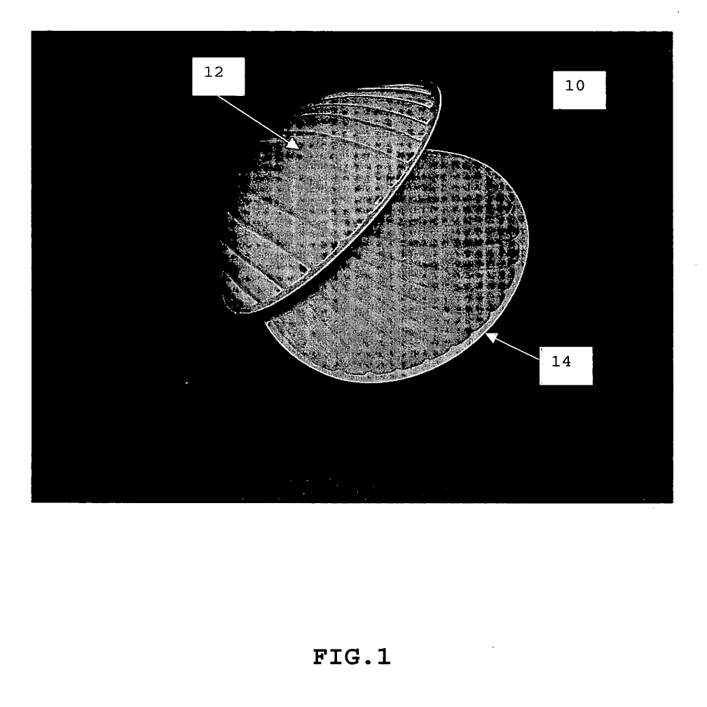

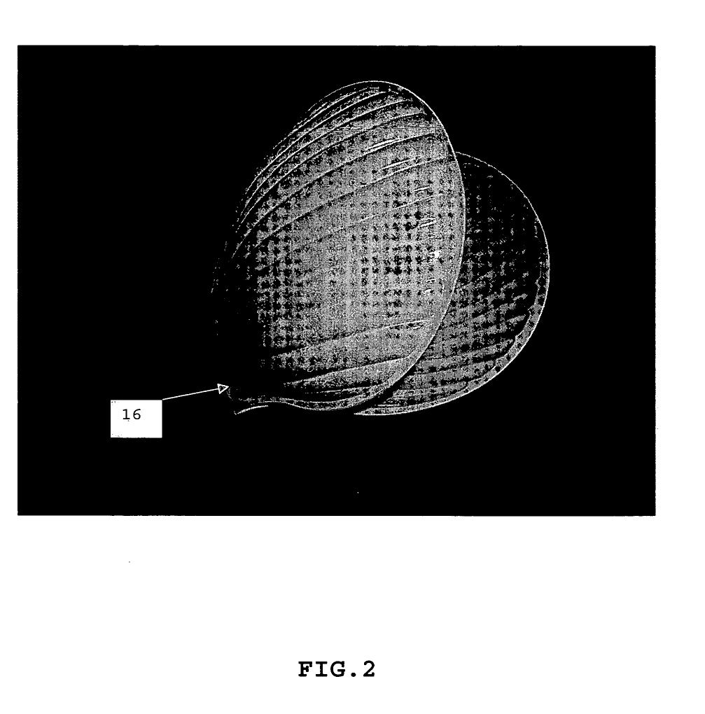

Referring now to FIG. 1, the preferred embodiment of the present invention is shown as disposable butter container and dispenser 10. As illustrated in FIG. 1, disposable butter container and dispenser 10 includes an upper container member 12 and a lower container member 14. Upper container member 12 and a lower container member 14 are preferably formed affixed together as a single unitary construction. As shown in FIG. 2, hinge member 16 connects upper container member 12 and a lower container member 14.

Hinge member 16 is formed as an integrated portion of the single unitary construction. Additionally, hinge member 16 is under internal bias pressure as a result of the memory properties of the material forming hinge member 16 (as well as upper container member 12 and lower container member 14). Due to the internal bias pressure imparted to hinge member 16 by the memory properties of the material forming hinge member 16, hinge member 16 forces upper container member 12 into a first position relative to lower container member 14. In the preferred embodiment of the present invention, the first position is an open position.

A tab member (not shown) can be used to secure upper container member 12 into a second position relative to lower container member 14. In the preferred embodiment of the present invention, the second position is a closed position. The tab member can include an adhesive, so that the tab member can be affixed to upper container member 12 and lower container member 14 after manufacture and subsequent to placing the butter into disposable butter container and dispenser 10.

Incorporating a tab member to counteract the force supplied by hinge member 16, due to its internal bias pressure, permits disposable butter container and dispenser 10 to be sealed closed until it is to be used. Once use of disposable butter container and dispenser 10 is desired, the tab member is removed. Removal of the tab member results in the internal bias pressure of hinge 16 to separate upper container member 12 from lower container member 14, thereby permitting access to the contents (butter) therein.

As a result of using internal bias pressure to separate upper container member 12 from lower container member 14, disposable butter container and dispenser 10 provides a more sanitary and hygienic manner in which one can access butter. This is due to the constant open position of disposable butter container and dispenser 10 that provides separation of upper container member 12 from lower container member 14. Since disposable butter container and dispenser 10 is constantly open upon removal of the tab member, unclean hands need not touch the device of the present invention.

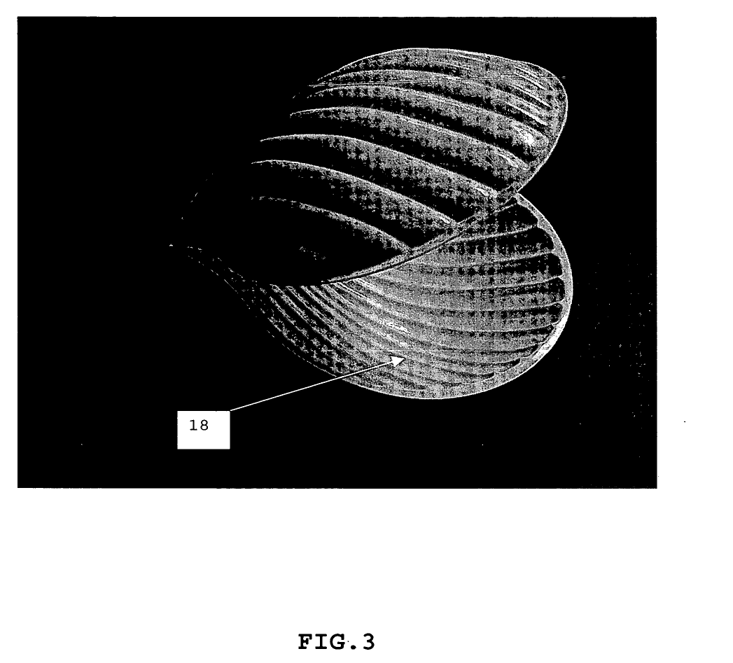

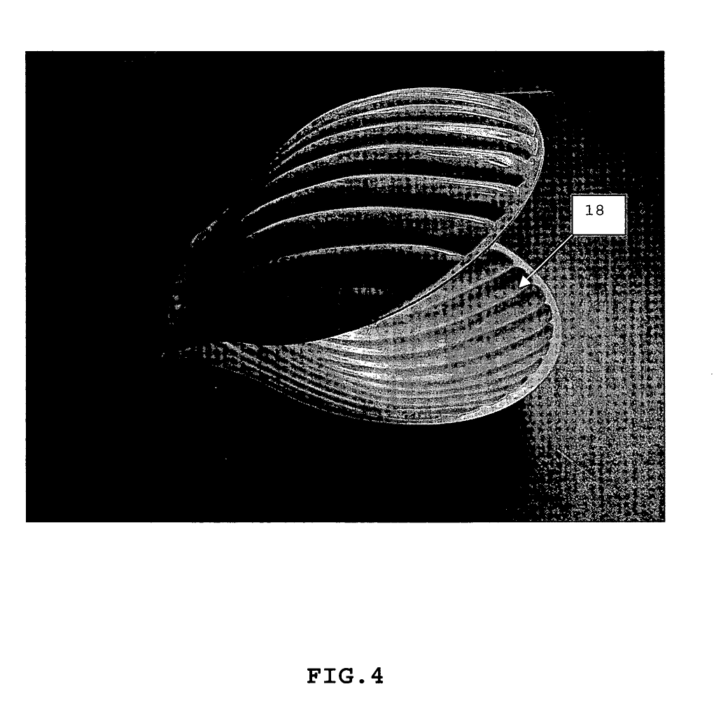

Referring now to FIGS. 3 and 4, disposable butter container and dispenser 10 is illustrated including a plurality of support ridges 18 integrally formed on an internal surface of lower container member 14. Support ridges 18 reduce the contact area of the butter contained within disposable butter container and dispenser 10, thereby reducing the degree of adherence by the butter, a problem well known in the art.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following numbered claims and accompanying drawings.

1. A disposable butter container and dispenser, comprising:
an upper container member;
a lower container member;.
a hinge member under internal bias pressure integrated to said upper container member and said lower container member, wherein said hinge member under internal bias pressure places said upper container member in a first position relative to said lower container member; and
a tab member to secure said upper container member in a second position relative to said lower container member.

2. The disposable butter container and dispenser according to claim 1 further comprising a plurality of support ridges formed on an internal surface of said lower container member.
